(19) United States
(12) Patent Application Publication
(10) Pub. No.: US 2025/0109300 A1
(43) Pub. Date: Apr. 3, 2025

(54) COATINGS CONTAINING HYBRID METAL OXIDE PARTICLES

(71) Applicant: BASF SE, Ludwigshafen am Rhein (DE)

(72) Inventors: Nicholas A. FOLEY, Charlotte, NC (US); Christopher J. VALOVIC, Charlotte, NC (US); Rupa Hiremath DARJI, Tarrytown, NY (US); Michael David BURKE, Tarrytown, NY (US); Keith TASK, Beachwood, OH (US); Carmen A. HENDRICKS-GUY, Tarrytown, NY (US); Liangliang QU, Tarrytown, NY (US)

(21) Appl. No.: 18/729,042

(22) PCT Filed: Jan. 16, 2023
(86) PCT No.: PCT/US2023/010872

§ 371 Date: Jul. 15, 2024

Related U.S. Application Data
(60) Provisional application No. 63/300,372, filed on Jan. 18, 2022.

(51) Int. Cl. C09D 5/33; C08K 9/02; C09D 7/40; C09D 7/62

(52) U.S. Cl. CPC C09D 5/004; C09D 7/62; C09D 7/67; C09D 7/68; C09D 7/69; C08K 9/02; C08K 2201/005; C08K 2201/011

(57) ABSTRACT

Coating compositions comprising a polymer binder and hybrid metal oxide particles are described herein.

### CROSS-REFERENCE TO RELATED APPLICATION(S)

This application claims the benefit of priority of U.S. Provisional Patent Application No. 63/300,372, filed Jan. 18, 2022, the disclosure of which is hereby incorporated by reference herein in its entirety.

### FIELD OF THE DISCLOSURE

The present disclosure relates to colored coating compositions, particularly to coating compositions comprising metal oxide-based materials.

### BACKGROUND

Color is one of the most important aspects of printing inks and paints. Printing inks are used for generating images and text on a variety of consumer and industrial goods. A primary function of the image and text is to identify and differentiate the printed object. The value of image and text can be directly related to the quality of the image including its color. One of the primary purposes of paints is also to provide a specific color to the underlying substrate. The value of a paint can also be directly related to its ability to provide a specific color.

Numerous mechanisms for the generation of color have been identified. These mechanisms are categorized into those that are caused by atomic excitations, ligand field effects, molecular orbital transitions, band transitions, or phenomena occurring due to geometric or physical causes. Of all these mechanisms, the use of color by humans has traditionally been dominated by materials that harness the effects of electronic transitions. Specifically, the color of a printing ink and paint is primarily derived from pigments or dyes that use color mechanisms that selectively subtract specific parts of the visible spectrum through electronic transitions and reflect or transmit the remaining visible wavelengths. A majority of the objects in our world follow this mechanism, where color is dictated by the selective absorbance of light. This subtractive color mechanism is distinct from colors that arise from the mixing of colored light, called ‘additive color’. Additive coloration is used in display systems such as monitors and televisions in which numerous colored pixels are selectively activated to combine specific colored emissions into a desired final color. In this case, photons are not being selectively absorbed but, rather, narrow band emissions of specific wavelengths of photons are responsible for the perceived color. The emitted color wavelengths from each individual source add together to form the final color.

One important requirement for conservation of coatings is their protection from damage caused by environmental conditions. A primary environmental concern is radiation including ultraviolet (UV), visible, and infrared (IR) radiation. Molecules of all types are excited by and selectively absorb energy from radiation at specific wavelengths across the electromagnetic spectrum. For example, most organic polymers used in coatings are excited by and absorb radiation at a variety of specific wavelengths in the IR and UV regions of the electromagnetic spectrum. While the exact nature of the changes will depend upon the organic polymer structure, the net effect of radiation is a marked change (deterioration) in physical, chemical, and performance properties of the coatings. Heat is also a direct consequence of either visible or infrared radiation incident on coatings.

Coatings having various functionalities, specifically how they interact with natural electromagnetic radiation, is commonly adopted in the coating industry. Coatings are designed to reflect or absorb certain wavelengths of incident radiation, depending upon the application. Currently, a wide range of technologies exists to help mitigate these various incident wavelengths of radiation. However, there is still a need for coatings with improved electromagnetic radiation mitigation effects. There is a need to formulate coatings which have improved wavelength selective scattering particles. The compositions and methods described herein address these and other needs.

### SUMMARY OF THE DISCLOSURE

The following summary presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

Coating compositions comprising a polymer binder and particles (e.g., microspheres) selected from metal oxide particles (e.g., such as hybrid metal oxide particles), are described herein. The particles can have an average particle size diameter of about 100 μm or less, from about 0.5 μm to about 100 μm, or from about 1 μm to about 20 μm, e.g., from about 0.5 μm to about 10 μm, from about 0.5 μm to about 5 μm, or from about 3 μm to about 5 μm. A problem solved with the use of the particles include enhancement of the characteristics of the coating compositions with respect to electromagnetic radiation (color characteristics, reflective characteristics, opacity characteristics, etc.). In particular, the particles can exhibit a structural color which may be angle dependent or angle independent.

Coating compositions of the present disclosure can exhibit UV reflectance, visible light reflectance, IR reflectance, or a combination thereof. For example, the coating compositions comprising the particles described herein, when dried, can exhibit UV reflectance within a wavelength range of 100 nm to 400 nm, a visible light absorbance at a wavelength range from 400 nm to 800 nm, visible light reflectance within a wavelength of from 400 to 700 nm, IR reflectance within a wavelength from 800 nm to 10 μm, or a combination thereof. The compositions may also exhibit improved opacity within a wavelength from 100 nm to 800 nm. In some instances, the coating compositions can be aqueous compositions.

The polymer binder present in the coating compositions can comprise a polymer selected from acrylic homopolymers, styrene-acrylic-based copolymers, styrene-butadiene-based copolymers, styrene-butadiene-styrene block copolymers, vinyl acrylic-based copolymers, ethylene vinyl acetate-based copolymers, polychloroprene, alkyd resin, polyester resins, polyurethane resins, silicone resins, petroleum resins, epoxy resins, or blends thereof. The polymer binder can be present in an amount of from greater than 0% to 99.9% by weight, or from 5% to 99.9% by weight, or from 10% to 95% by weight, based on a dry weight of the coating composition.

As described herein, the particles in the coating compositions can comprise hybrid metal oxide particles. In some examples, the coating compositions comprise the hybrid metal oxide particles. The hybrid metal oxide particles can have a unimodal or multimodal distribution of occlusion sizes, such as a bimodal distribution of occlusion sizes. The average occlusion diameter of the hybrid metal oxide particles can be from about 50 nm to about 10 μm, from about 50 nm to about 5 μm, from about 50 nm to about 2.5 μm, from about 50 nm to about 1 μm, from about 200 nm to about 800 nm, from about 200 nm to about 400 nm, or from about 250 nm to about 350 nm. The metal oxides forming the hybrid metal oxide particles be independently selected from the group consisting of silica, titania, alumina, zirconia, ceria, iron oxides, zinc oxide, indium oxide, tin oxide, chromium oxide, and combinations thereof, such as titania or silica.

The coating compositions can further comprise one or more pigments or fillers, for example, pigments or fillers selected from clay, kaolin, mica, titanium dioxide, talc, natural silica, synthetic silica, natural silicates, synthetic silicates, feldspars, nepheline syenite, wollastonite, diatomite, barite, glass, and calcium carbonate, bentonite, attapulgite, zeolite, or mixtures thereof. The one or more pigments or fillers can be present in an amount such that the particles and one or more pigments or fillers make up from greater than 0% to 90% by weight, or from 0.1% to 60% by weight, based on a total weight of the coating composition. In some examples, the coating compositions do not include a pigment or filler, other than the particles.

The coating compositions can further include a pigment dispersant, an inorganic or organic filler, a pigment extender, an adhesion enhancer, a film forming aid, a defoamer, a thickener, a light stabilizer, a wetting agent, a biocide, a tackifier, or a combination thereof.

In specific examples, the coating compositions can be UV reflective composition, such as clear coating compositions. Clear coating compositions comprising a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof; and particles comprising hybrid metal oxide particles, wherein the particles have an average particle size diameter of from about 0.5 μm to about 10 μm, from about 0.5 μm to about 5 μm, or from about 0.5 μm to about 3 μm, and wherein the clear coating composition when dried exhibits a UV reflectance at a wavelength range from 100 nm to 400 nm, are disclosed herein. In certain embodiments, the UV reflective compositions comprise hybrid metal oxide particles having an average diameter of from about 0.5 μm to about 10 μm, from about 0.5 μm to about 5 μm, or from about 0.5 μm to about 3 μm; and an average occlusion diameter of from about 50 nm to about 400 nm or from about 50 nm to about 200 nm. The UV reflective compositions can further comprise one or more UV absorbers, such as those selected from a hydroxy-phenyl-benzotriaziole, a hydroxy-phenyl-triazine, a hydroxyl-benzophenone, an oxanilide, a cyanoacrylate, a malonate, and a mixture thereof.

In other specific examples, the coating compositions exhibits improved opacity, such as when incorporated in paints. Paint compositions comprising a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof.

In other specific examples, a colored coating can be an architectural colored coating composition. The architectural colored coating composition can comprise a polymer binder; and hybrid metal oxide particles, wherein the particles have an average particle size diameter of from about 0.5 μm to about 20 μm, e.g., from about 0.5 μm to about 10 μm, from about 0.5 μm to about 5 μm, or from about 3 μm to about 5 μm and exhibits a structural color visible to the human eye, and wherein the architectural colored coating composition when dried, exhibits visible light absorbance at a wavelength range from 400 nm to 800 nm.

In other specific examples, the colored coating can include a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, alkyd resin, polyester resins, polyurethane resins, silicone resins, petroleum resins, epoxy resins, blends thereof, or copolymers thereof; and hybrid metal oxide particles, and wherein the particles have an average particle size diameter of from about 0.5 μm to about 20 μm, e.g., from about 0.5 μm to about 10 μm, from about 0.5 μm to about 5 μm, or from about 3 μm to about 5 μm and exhibits an angle-independent structural color.

In other specific examples, the coating compositions exhibits improved opacity, such as when incorporated in paints. Paint compositions comprising a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof; and hybrid metal oxide particles, wherein the particles have an average particle size diameter of, e.g., about 100 μm or less, from about 0.5 μm to about 100 μm, or from about 0.5 μm to about 10 μm are disclosed herein. In certain embodiments, the coating compositions exhibiting improved opacity comprise hybrid metal oxide particles having an average diameter of from 0.5 μm to 100 μm or from 0.5 μm to 10 μm; and an average occlusion diameter of from about 50 nm to about 800 nm, from about 50 nm to about 400 nm, or from about 100 nm to about 200 nm. A wet film having a thickness of about 75 μm and formed from the coating compositions exhibiting improved opacity such as paint compositions can exhibit a light scattering coefficient of greater than 1 S/mil, or greater than 3 S/mil, and an absorption coefficient of less than 0.02 K, as determined according to BS EN ISO 6504-1. The film can exhibit a contrast ratio of at least 90% or greater than 96%. Compositions having improved opacity can be selected from an aqueous based paint or an oil based paint or selected from an industrial paint or an architectural paint for interior and exterior applications.

In other specific examples, the coating compositions can be IR reflective coating composition. The IR reflective coating composition may comprise a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, alkyd resin, polyester resins, polyurethane resins, silicone resins, petroleum resins, epoxy resins, blends thereof, or copolymers thereof; and hybrid metal oxide particles, wherein the particles have, e.g., an average particle size diameter of about 5 μm or greater or from about 5 μm to about 100 μm, and wherein the coating composition when dried exhibits an IR reflectance at a wavelength range from, e.g., 800 nm to 10 μm, from 800 nm to 2.5 μm, or from 800 nm to 1 μm, are disclosed herein.

In certain embodiments, a coating formed from the IR reflective composition exhibits IR reflectance at a wavelength from 800 nm to 10 μm of at least 10%, at least 20%, at least 40%, or at least 50%. In certain embodiments, the hybrid metal oxide particles have an average occlusion diameter from about 400 nm to about 10 μm, from about 400 nm to about 5 μm, from about 400 nm to about 2.5 μm, from about 400 nm to about 1 μm, or from about 400 nm to about 700 nm.

In certain embodiments, the IR reflective coating compositions comprise hybrid metal oxide particles having an average diameter of from greater than about 5 μm to about 100 μm; and an average occlusion diameter of from about 400 nm to about 5 μm, from about 400 nm to about 2.5 μm, or from about 400 nm to about 1 μm.

Coatings and films formed from the coating compositions are also disclosed. The coating compositions can be in the form of an ink or a coating, such as a paint. The paint can be an aqueous based paint or an oil-based paint, such as selected from an industrial paint, an automotive paint, an aerospace paint, or an architectural paint for interior and exterior applications. The films can have a thickness of from about 0.5 to about 500 μm, from about 5 to about 75 μm, or from about 0.5 to about 30 μm, after drying. In certain embodiments, the films can exhibit a UV reflectance at a wavelength from 100 nm to 400 nm of at least 10%, at least 20%, at least 40%, or at least 50%. In other embodiments, the films can exhibit an IR reflectance at a wavelength from 800 nm to 10 μm, from 800 nm to 5 μm, from 800 nm to 2.5 μm, or from 800 nm to 1 μm, of at least 10%, at least 20%, at least 40%, or at least 50%. In further embodiments, the films having a thickness of 75 μm, exhibit a contrast ratio of at least 90%, or at least 96%.

Methods of protecting a substrate against UV-radiation or IR-radiation comprising applying a coating composition disclosed herein are also provided. The substrate can be an architectural structure, glass, metal, wood, plastic, concrete, vinyl, ceramic material or another coating layer applied on such a substrate.

The details of one or more embodiments are set forth in the description below. Other features, objects, and advantages will be apparent from the description and from the claims.

### BRIEF DESCRIPTION OF THE DRAWINGS

The disclosure described herein is illustrated by way of example and not by way of limitation in the accompanying figures.

FIG. 1 illustrate hybrid metal oxide particles formed from template and matrix metal oxide particles according to certain embodiments of the present disclosure.

FIG. 2 illustrates a comparison of the structure of hybrid metal oxide particles prepared according to certain embodiments of the present disclosure to porous metal oxide particles.

FIG. 3 shows a schematic of an exemplary spray drying system used in accordance with various embodiments of the present disclosure.

FIG. 4 is plot of UV attenuation for a coating prepared with hybrid metal oxide particles compared to a control coating prepared without hybrid metal oxide particles.

FIG. 5 shows scanning electron micrographs of hybrid metal oxide particles prepared from silica nanosphere templates with a zinc oxide matrix.

### DETAILED DESCRIPTION

Embodiments of the present disclosure relate to coating compositions that utilize materials having properties by which electromagnetic properties of the coating composition can be adjusted. Such properties include absorbance and/or reflectance of light in the visible, infrared (IR), and ultraviolet (UV) spectra. Certain embodiments relate to coating compositions that incorporate hybrid metal oxide particles, which have physical parameters that can be tuned to enhance performance properties of their corresponding coating compositions, for example, by modifying the shape, size, and morphology of the particles in lieu of or in addition to modifying their chemical properties.

The terms “tuned,” “adjusted,” and “configured” can be used interchangeably and refer to an adjustment to a physical and/or chemical characteristic of the particles to change their reflectance properties. By way of example, and not to be considered limiting, such physical characteristics that can be adjusted include the particle size diameters, particle size distributions, particle shapes, void (pore) diameter within the particles, porosity, packing density, surface texture, and the degree of order with regard to the spatial arrangement of the voids (pores) in the particles. Chemical characteristics that can be adjusted include the chemical make-up of the particles. When used in coating compositions, the particles can be added in a sufficient amount to enhance reflective properties and optionally replace existing components such as pigments and/or fillers in the coating compositions.

Certain embodiments relate to the use of particles that are structurally colored. The terms “structurally colored” or “structural colorants” can be used interchangeably and refer to particles that form colors due to their structural morphology rather than molecular properties. In particular, the particle exhibit color via light interference effects, relying on microscopically structured surfaces small enough to interfere with visible light and produce color as opposed to their chemical structure. The colors that result from this mechanism can be selected by alterations to the structure of a chosen material, allowing one material to exhibit various colors throughout the visible spectrum with no change to the chemical nature of the material itself. The creation of these particles through a sacrificial templating procedure or colloidal dispersion procedure and their optimization for color is discussed herein.

The particles described herein can exhibit high stability and thus can be formulated into colored coating compositions as a replacement for less stable and/or less environmentally friendly pigments or dyes. “Coating composition,” as used herein, is a generic term for a surface coating and refers to a composition that includes a vehicle containing a polymer binder component and a pigment or filler dispersed into the vehicle. The coating compositions described herein can include an aqueous or non-aqueous vehicle; a polymer binder; particles (e.g., microspheres) selected from metal oxide particles (as discussed in greater detail below), polymer microspheres, or combinations thereof; and optionally one or more pigments or fillers. The coating compositions when dried, exhibit visible light reflectance, ultraviolet (UV) reflectance, IR reflectance, or a combination thereof. In certain embodiments, the dried coating compositions exhibit a UV, visible light, or IR absorbance of at least 10%, 20% or greater, 30% or greater, 40% or greater, or 50% or greater. Reflectance or reflectivity is expressed in terms of percentage of incident light that is scattered or reflected away from a surface. Absorbance or absorptivity is expressed in terms of percentage of incident light that is scattered or reflected away from a surface absorbed into the coating.

In certain embodiments, the coating compositions comprising the particles disclosed herein provide UV absorption functionality. The coating compositions can be coated on or incorporated into a substrate. The substrate can include, e.g., plastics, wood, fibers or fabrics, ceramics, glass, metals, and composite products thereof.

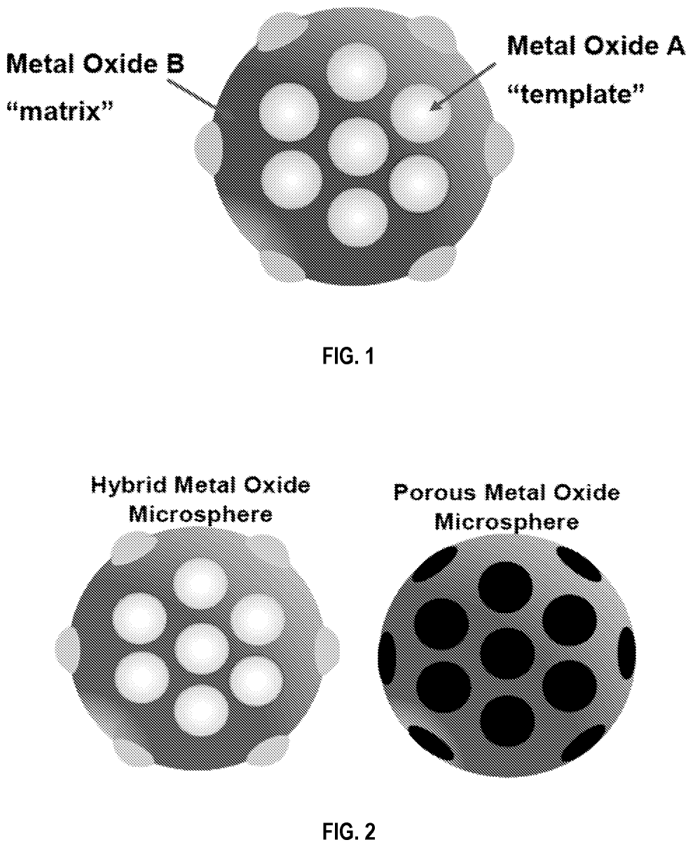

The metal oxide particles utilized in various embodiments herein may include hybrid metal oxide particles, which comprise are particles that comprise a metal oxide matrix in which is embedded a template of spherical nanoparticles comprised of another metal oxide as shown in FIG. 1.

In certain embodiments, the hybrid metal oxide particles are produced by drying droplets of a formulation comprising a matrix of first metal oxide particles (referred to as “matrix” nanoparticles) on the order of 1 to 120 nm in diameter, and second metal oxide nanoparticles (e.g., spherical nanoparticles) on the order of 50 to 999 nm which will form the template (referred to as “template” nanoparticles). In certain embodiments, a spray drying or microfluidics process is used to generate the droplets (e.g., aqueous droplets), and the droplets are dried to remove their solvent. In certain embodiments that utilize a spray drying process, the generation of droplets and drying is performed in rapid succession. During the drying process, the template nanoparticles (metal oxide A of FIG. 1) self-assemble to form a microsphere containing a discrete matrix of metal oxide B particles in which are embedded the template nanoparticles of metal oxide A. The dried particles are then heated under conditions suitable for forming a continuous matrix from the metal oxide B particles in which the metal oxide A particles are embedded. For example, by sintering the matrix nanoparticles (which may contain multiple metal oxides) in a muffle furnace, the matrix nanoparticles densify and form a stable, continuous matrix with the template nanoparticles being retained within the structure. In certain embodiments, the droplets further contain a binder (e.g., a material selected from boehmite, alumina sol, silica sol, titania sol, zirconium acetate, ceria sol, or combinations thereof). The dried droplets are then heated under conditions suitable to cause the binder and the metal oxide B particles to form the continuous matrix (e.g., at a temperature of about 300° C. to about 800° C. for a period of about 1 hour to about 8 hours). This final structure is a relatively non-porous solid particle when compared with porous metal oxide microspheres as shown in FIG. 2.

An advantage of this system over a porous metal oxide microsphere is that media infiltration is prevented. The retention of the template in the hybrid metal oxide microsphere ensures that the media cannot infiltrate the structure as it would the voids of the porous metal oxide microsphere. Preventing infiltration of polymers, large molecules, or other viscous materials frequently used in such coating formulations maintains a constant net refractive index between the matrix and the embedded “occlusions” (regions of different metal oxide composition formed by the template nanoparticles) regardless of the surrounding media in the application.

Depending upon the physical characteristics of the hybrid metal oxide particles, they can have a broad range of uses in coating compositions. The hybrid metal oxide particles can be synthesized as to adjust (1) the hybrid metal oxide particles diameter, (2) the template nanoparticle metal oxide composition, (3) the matrix nanoparticle metal oxide composition, (4) the diameter of the template nanoparticle metal oxide occlusions within the matrix nanoparticles, (5) the degree of order with regard to the spatial arrangement of the occlusions in the hybrid metal oxide particles, and (6) the average distance between the occlusions (template nanoparticles). When used in coating compositions, the hybrid metal oxide particles can be added as such to enhance existing properties and/or replace existing components in the coating.

An additional benefit of the hybrid metal oxide particles is the capability to add materials into the metal oxide occlusions. Since these occlusions are typically retained in the structure of the hybrid metal oxide particles, a material which enhances or imparts a desired effect (for example, a light absorber) can be incorporated into the template and be retained within the structure.

Non-limiting examples of exemplary components used in coating compositions are now described.

### Polymer Binder

As described herein, the coating compositions include a polymer binder and particles (e.g., microspheres). The term “binder” (which also may be referred to interchangeably as “resin”) refers to polymers that are included in the coating composition and that augment or participate in film formation and in the composition of the resultant film.

The specific polymer in the polymer binder can depend on the application of the coating compositions as well as other components of the coating compositions, such as an aqueous or non-aqueous vehicle. In certain embodiments, the polymer binder can include a polymer selected from acrylic homopolymers (i.e., a polymer derived from one or more acrylic monomers), styrene-acrylic-based copolymers (i.e., a polymer derived from styrene and one or more (meth)acrylic monomers), styrene-butadiene-based copolymers (i.e., a polymer derived from styrene and one or more diene monomers such as 1,2-butadiene, 1,3-butadiene, 2-methyl-1,3-butadiene, or 2-chloro-1,3-butadiene), styrene-butadiene-styrene block copolymers, vinyl acrylic-based copolymers (i.e., a polymer derived from one or more vinyl ester monomers and one or more (meth)acrylic monomers), ethylene vinyl acetate-based copolymers (i.e., a polymer derived from ethylene and vinyl acetate), a vinyl chloride-based polymer (i.e., a polymer derived from one or more vinyl chloride monomers such as polyvinyl chloride), polychloroprene (i.e., a polymer derived from chlorinated diene monomers), a vinyl alkanoate-based polymer (i.e., a polymer derived from one or more vinyl alkanoate monomers, such as polyvinyl acetate or a copolymer derived from ethylene and vinyl acetate monomers), alkyd resin, polyester resin, polyurethane resin, an acrylic-polyurethane hybrid polymer, silicone resin, petroleum resin, epoxy resin, or blends thereof.

In certain embodiments, the polymer (e.g., an acrylic homopolymer or a styrene-acrylic based copolymer) in the polymer is derived from one or more (meth)acrylate and/or (meth)acrylic acid monomers. The term “(meth)acryl . . . ,” as used herein, includes acryl . . . , methacryl . . . , and also includes diacryl . . . , dimethacryl . . . polyacryl . . . and polymethacryl . . . or mixtures thereof. For example, the term “(meth)acrylate monomer” includes acrylate and methacrylate monomers, diacrylate and dimethacrylate monomers, and other polyacrylate and polymethacrylate monomers. Suitable (meth)acrylate monomers include esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate). Specific examples of suitable (meth)acrylate monomers for use in the polymer binder include methyl (meth)acrylate, ethyl (meth)acrylate, n-butyl (meth)acrylate, iso-butyl (meth)acrylate, tert-butyl (meth)acrylate, isobutyl (meth)acrylate, n-hexyl (meth)acrylate, 2-ethylhexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, or combinations thereof. Other suitable (meth)acrylate monomers include alkyl crotonates, acetoacetoxyethyl (meth)acrylate, acetoacetoxypropyl (meth)acrylate, hydroxyethyl (meth)acrylate, 2-ethoxyethyl (meth)acrylate, 2-methoxy (meth)acrylate, 2-(2-ethoxyethoxy)ethyl (meth)acrylate, 2-phenoxyethyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

The polymer in the polymer binder can include a (meth)acrylate monomer in an amount of 5% or greater by weight, based on the weight of the polymer. For example, the (meth)acrylate monomer can be in an amount of 7% or greater, 10% or greater, 20% or greater, 30% or greater, 40% or greater, 50% or greater, 60% or greater, 65% or greater, 70% or greater, 75% or greater, 80% or greater, 85% or greater, 90% or greater, 95% or greater, or up to 100% by weight, based on the weight of the polymer. In certain embodiments, the (meth)acrylate monomer can be in an amount of 100% or less, 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. The polymer can be derived from any of the minimum values to any of the maximum values by weight described above of the (meth)acrylate monomers. For example, the (meth)acrylate monomer can be in an amount of from greater than 0% to 100%, 20% to 100%, 40% to 95%, 50% to 95%, 65% to 95%, or 65% to 85% by weight, based on the weight of the polymer.

In certain embodiments, the polymer in the polymer binder can be derived from (meth)acrylic acid monomers. Examples of suitable (meth)acrylic acid monomers include α,β-monoethylenically unsaturated mono- and dicarboxylic acids having 3 to 6 carbon atoms. Specific examples of suitable (meth)acrylic acid monomers include acrylic acid, methacrylic acid, maleic acid, fumaric acid, or itaconic acid, crotonic acid, dimethacrylic acid, ethylacrylic acid, allylacetic acid, vinylacetic acid, mesaconic acid, methylenemalonic acid, citraconic acid, or mixtures thereof. The polymer can be derived from 0%, 0.5% or greater, 1.0% or greater, 1.5% or greater, 2.5% or greater, 3.0% or greater, 3.5% or greater, 4.0% or greater, or 5.0% or greater, by weight of a (meth)acrylic acid monomer. In certain embodiments, the polymer can be derived 25% or less, 20% or less, 15% or less, or 10% or less, by weight of a (meth)acrylic acid monomer. In certain embodiments, the polymer can be derived from 0.5%-25%, from 0.5%-10%, from 1.0%-9%, from 2.0%-8% or from 0.5%-5%, by weight of a monomer.

In certain embodiments, the polymer in the polymer binder includes vinyl aromatic monomers (e.g., styrene). For example, the polymer binder can include a styrene-acrylic-based copolymer, a styrene-butadiene-based copolymer, a styrene-butadiene-styrene block copolymer, or a mixture thereof. Suitable vinyl aromatic monomers for use in the copolymers can include styrene or an alkyl styrene such as a- and p-methylstyrene, a-butylstyrene, p-n-butylstyrene, p-n-decylstyrene, vinyltoluene, and combinations thereof. The vinyl aromatic monomer can be present in an amount of 0% by weight or greater (e.g., 1% or greater, 2% or greater, 5% or greater, 10% or greater, 15% or greater, 20% or greater, 25% or greater, 30% or greater, 40% or greater, 50% or greater, 60% or greater, 65% or greater, 70% or greater, 75% or greater, 80% or greater, or 85% or greater by weight), based on the total weight of monomers from which the polymer is derived. In certain embodiments, the vinyl aromatic monomer can be present in the polymer in an amount of 90% by weight or less (e.g., 85% or less, 80% or less, 75% or less, 70% or less, 65% or less, 60% or less, 55% or less, 50% or less, 45% or less, 40% or less, 35% or less, 30% or less, 25% or less, 15% or less, or 10% or less by weight), based on the total weight of monomers from which the polymer is derived. The polymer can be derived from any of the minimum values to any of the maximum values by weight described above of the vinyl aromatic monomer. For example, the polymer can be derived from 0% to 90% by weight (e.g., from 0% to 60%, from 0% to 45%, from 2% to 85%, from 2% to 60%, from 2% to 40%, from 5% to 85%, from 5% to 75%, from 5% to 60%, from 5% to 50%, from 5% to 35%, from 0% to 15%, from 0% to 10%, from 2% to 10%, or from 0% to 5% by weight of vinyl aromatic monomer), based on the total weight of monomers from which the polymer is derived.

When used, the styrene-acrylic-based copolymer can include styrene, a (meth)acrylate monomer, and optionally, one or more additional monomers. In certain embodiments, the weight ratio of styrene to the (meth)acrylate monomer in the polymer can be from 1:99 to 99:1, from 10:99 to 99:10, from 5:95 to 95:5, from 5:95 to 80:20, from 20:80 to 80:20, from 5:95 to 70:30, from 30:70 to 70:30, or from 40:60 to 60:40. For example, the weight ratio of styrene to the (meth)acrylate monomer can be 25:75 or greater, 30:70 or greater, 35:65 or greater, or 40:60 or greater. In some examples, the polymer can be a random copolymer, such as a random styrene-(meth)acrylate copolymer.

In certain embodiments, the polymer in the polymer binder can be derived from one or more ethylenically-unsaturated monomers selected from anhydrides of α,β-monoethylenically unsaturated mono- and dicarboxylic acids (e.g. maleic anhydride, itaconic anhydride, and methylmalonic anhydride); acrylamides and alkyl-substituted acrylamides (e.g. (meth)acrylamide, N-tert-butylacrylamide, and N-methyl(meth)acrylamide); (meth)acrylonitrile; 1,2-butadiene (i.e. butadiene); vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with Ci-Cis alcohols alkoxylated with from 2 to 50 mole of ethylene oxide, propylene oxide, butylene oxide or mixtures thereof (e.g. hydroxyethyl (meth)acrylate, hydroxypropyl (meth)acrylate, and methylpolyglycol acrylate); monomers containing glycidyl groups (e.g. glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3-(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP).

The polymer in the polymer binder can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In certain embodiments, the polymer can include from 0.01% to 5% by weight of the polymer, of the crosslinking agent.

The polymer can have a glass-transition temperature (T_{g}), as measured by differential scanning calorimetry (DSC) using the mid-point temperature as described, for example, in ASTM 3418/82, of from −90° C. to 100° C. In certain embodiments, the polymer has a measured T_{g} of −90° C. or greater (for example, −80° C. or greater, −70° C. or greater, −60° C. or greater, −50° C. or greater, −40° C. or greater, −30° C. or greater, −20° C. or greater, −10° C. or greater, 0° C. or greater, 10° C. or greater, 20° C. or greater, 30° C. or greater, 40° C. or greater, 50° C. or greater, 60° C. or greater, 70° C. or greater, or 80° C. or greater). In some cases, the polymer has a measured T_{g} of 100° C. or less (e.g., less than 100° C., 90° C. or less, 80° C. or less, 70° C. or less, 60° C. or less, 50° C. or less, 40° C. or less, 30° C. or less, 25° C. or less, 20° C. or less, 10° C. or less, 0° C. or less, −10° C. or less, −20° C. or less, −25° C. or less, −30° C. or less, −35° C. or less, −40° C. or less, −45° C. or less, or −50° C. or less). In certain embodiments, the polymer has a measured T_{g} of from −90° C. to 90° C., from −90° C. to 50° C., from −90° C. to 40° C., from −90° C. to 30° C., from −90° C. to 25° C., −90° C. to 0° C., −90° C. to −10° C., from −80° C. to 25° C., from −80° C. to 10° C., from −80° C. to 0° C., from −80° C. to −10° C., from −60° C. to 30° C., from −60° C. to 25° C., from −60° C. to 0° C., from −60° C. to less than 0° C. or from −40° C. to less than 0° C.

The polymer binder can be formed from an aqueous dispersion, for example, an aqueous latex dispersion. In certain embodiments, the polymer binder can include an aqueous latex dispersion of an acrylic homopolymer, a vinyl-aromatic-acrylic polymer, a vinyl-acrylic polymer, a vinyl chloride polymer, an acrylic-polyurethane hybrid polymer, a vinyl alkanoate polymer, or a combination thereof.

Typical polymer binders used in coating compositions for applications such as paints and inks are known in the art. For example, paint and ink formulations can include polymer binders commercially available under the trade name ACRONAL® (available from BASF), JONCRYL® (available from BASF), RHOPLEX® (available from The Dow Chemical Company), ROVACE® (available from The Dow Chemical Company), and EVOQUE® (available from The Dow Chemical Company).

### Particles

As described herein, the coating compositions include particles (e.g., microspheres). The term “particle,” as used herein, encompasses any particle, particularly, although not essentially, to a particle of circular cross-section, which has a largest dimension or mean diameter of at least 1 μm, e.g., from 1 m 10 to 100 μm, from 1 μm to 20 μm, from 1 μm to 10 μm, or from 1 μm to 5 μm. The term “particle,” may also encompass particles having a largest dimension or mean diameter of less than 1 μm, with particles of such dimensions being referred to herein as “nanoparticles.”

When an incident electromagnetic beam falls on a solid sample, reflection, transmission, and/or absorption can occur. The specific optical effect that occurs is dependent on the sample's physical characteristics and chemical composition. As such, the reflective and absorptive properties of the particles described herein can be independently tuned across several different wavelength-scales by modifying for example, the geometric properties and surface chemistry of the particles. Specifically, the particles described herein has a reflectance tuning ability in the whole range of the UV, visible, and IR regions as further discussed herein.

The particles can have reflective properties. The term “reflective” refers to an ability to scatter or reflect light of a particular wavelength from a surface. The particles described herein are capable of reflecting light of ultraviolet (UV), visible, or infrared (IR) wavelengths, or a combination thereof. Wavelengths in the UV region range from 10 nm to 400 nm, such as from 100 nm to 400 nm or from 200 to 400 nm. Wavelengths in the visible region range from 400 nm to 800 nm, such as from 400 nm to 650 nm, or from 450 nm to 650 nm. Wavelengths in the infrared region range from 800 nm to 10000 nm, such as from 800 nm to 5000 nm, from 800 nm to 2500 nm, or from 800 nm to 1000 nm. The particles described herein are also capable of reflecting light having a wavelength of from 100 nm to 800 nm, such as from 100 nm to 600 nm, from 200 nm to 800 nm, or from 200 to 400 nm, thus providing improved opacity. Spectroscopic methods for determining reflectance values of a solid substance, including the particles, are well known in the art and include, for example, pressing a neat powder of the solid substance and placing the powder sample into a chamber of a spectrophotometer equipped with a reflectance spectroscopy accessory.

For colored coating compositions described herein, the particles may have dimensions or other structural features suitable for imparting a color other than black or white. The particles can absorb and reflect visible light. In certain embodiments, the particles can reflect light having a wavelength in the visible portion of the electromagnetic spectrum, from about 400 nm to about 800 nm. For example, the color “blue” or “blue-violet” has a local maximum reflectance in the spectral region of from about 390 nm to about 490 nm. The color “green” has a local maximum reflectance in the spectral region of from about 491 nm to about 570 nm. The color “red” has a local maximum reflectance in the spectral region of from about 621 nm to about 740 nm. The color “cyan” is obtained by the addition of the blue and green light and has a local maximum reflectance in the spectral region of from about 390 nm to about 490 nm and 491 nm to about 570 nm. The color “magenta” is obtained by the addition of the blue and red light and has a local maximum reflectance in the spectral region of from about 390 nm to about 490 nm and 621 nm to about 740 nm. The color “yellow” has a local maximum reflectance in the spectral region of from about 560 nm to about 590 nm.

Color has three characteristics: hue, intensity, and value. “Hue” refers to a gradation, tint, or variety of a color. “Intensity”, “chroma”, and “saturation” are used interchangeably to refer to the strength or sharpness of a color. “Value” refers to a degree of lightness or darkness in a color. The particles can provide a desired color for the colored coatings compositions.

The structural color of the particles is an important advantage over traditional pigments that are based on light absorption through electronic effects. For conventional pigments, each color requires the use of one or more specific compounds. The particles, however, can employ a structural color mechanism that enables the use of a single material in order to achieve a wide range of spectral colors through the tailoring of the periodic spacing in the structure.

The particles utilized in the coating compositions described herein may include hybrid metal oxide particles, polymer microspheres, or a combination thereof. The particles, collectively, can have an average diameter of 1 about μm or greater, about 1.5 μm or greater, about 2 μm or greater, about 2.5 μm or greater, about 3 μm or greater, about 3.5 μm or greater, about 4 μm or greater, about 4.5 μm or greater, about 5 μm or greater, about 5.5 μm or greater, about 6 μm or greater, about 7 μm or greater, about 7.5 μm or greater, about 8 μm or greater, about 8.5 μm or greater, about 9 μm or greater, about 9.5 μm or greater, about 10 μm or greater, about 15 μm or greater, about 20 μm or greater, about 30 μm or greater, about 40 μm or greater, about 50 μm or greater, about 60 μm or greater, about 70 μm or greater, about 80 μm or greater, about 90 μm or greater, or about 100 μm or greater. In certain embodiments, the particles, collectively, can have an average diameter of about 100 μm or less, about 90 μm or less, about 80 μm or less, about 70 μm or less, about 60 μm or less, about 50 μm or less, about 40 μm or less, about 30 μm or less, about 20 μm or less, about 15 μm or less, about 10 μm or less, about 9.5 μm or less, about 9 μm or less, about 8.5 μm or less, about 8 μm or less, about 7.5 μm or less, about 7 μm or less, about 6.5 μm or less, about 6 μm or less, about 5.5 μm or less, about 5 μm or less, about 4.5 μm or less, about 4 μm or less, about 3.5 μm or less, about 3 μm or less, about 2.5 μm or less, about 2 μm or less, about 1.5 μm or less, or about 1 μm or less. The particles, collectively, can have an average diameter from any of the minimum values to any of the maximum values described above of the spheres. For example, the particles can have an average diameter of from about 1 μm to about 20 μm, from about 1 μm to about 15 μm, from about 1 μm to about 10 μm, from about 1 μm to about 7.5 μm, from about 1 μm to about 5 μm, such as from about 2 μm to about 5 μm, about 3 μm to about 20 μm, from about 3 μm to about 15 μm, from about 3 μm to about 10 μm, from about 3 μm to about 7.5 μm, from about 3 μm to about 5 μm, from about 3.5 μm to about 5 μm, from about 4 μm to about 5 μm, from about 3 μm to about 4.5 μm, or from about 3 μm to about 4 μm. As another example, the particles can have an average diameter from about 1 μm to about 100 μm, from about 5 μm to about 100 μm, from about 10 μm to about 50 μm, or from about 1 μm to about 3 μm.

The average particle diameter (also referred to herein as average particle size) of the particles can be determined by scanning electron microscopy (SEM) or transmission electron microscopy (TEM). Particle size may also be measured by laser light scattering techniques with dispersions or dry powders. Average particle size is synonymous with D50, meaning half of the population resides above this point, and half below.

As discussed herein, the UV, visible, or IR reflective properties and efficiencies of the coating compositions can be controlled by the physical and chemical properties of the particles. To find the optimum reflectance characteristics of the coating compositions, the particle properties can be tuned. In particular, the particles can be made highly reflective because their geometry, the number of pores within a given pigment that are active, and degree of order can be precisely controlled. In addition to their reflective properties, the particles can exhibit improved hiding capabilities. These features of the particles provide the capability of producing improved reflectance in coating compositions not previously attainable with conventional pigments, which lacked the tuning capabilities of the particles. For example, when the optimization parameters are maximized, the resultant coatings can have high reflectance in the UV, visible, or IR region, or a combination thereof.

### Hybrid Metal Oxide Particles

Certain embodiments utilize hybrid metal oxide particles in the various coating compositions described herein. Hybrid metal oxide particles may be produced, for example, as described in International Application No. PCT/IB2021/000485, filed on Jul. 21, 2021, the disclosure of which is hereby incorporated by reference herein in its entirety.

Hybrid metal oxide particles may be prepared according to various methods, including, but not limited to: (1) methods utilizing colloidal metal oxide matrix particles and colloidal metal oxide template particles; (2) methods utilizing colloidal metal oxide matrix particles, colloidal metal oxide template particles, and binder particles; (3) binder particles alone or binder particles in combination with colloidal metal oxide template particles; and (4) colloidal metal oxide template particles in combination with a sol-gel synthesized metal oxide matrix.

Method (1) utilizes metal oxide template particles embedded in discrete metal oxide matrix particles. The structure can be sintered, fusing the matrix particles into a continuous matrix of metal oxide.

Method (2) utilizes metal oxide template and matrix particles in combination with binder particles. The template particles are embedded in a matrix comprising discrete metal oxide matrix particles and binder particles. The structure is heated resulting in a reaction of the binder particles, which results in the formation of a continuous matrix in which are embedded the metal oxide template particles. In an illustrative example, silica particles are used as the template particles, alumina particles are used as the matrix particles, and boehmite is used as the binder particles. The silica template is embedded in a matrix of alumina and boehmite. The structure is heated to a temperature sufficient to dehydrate the boehmite into alumina, forming a continuous matrix of alumina. If different metal oxide template particles were used, such as titania, the result would be a continuous matrix comprising discrete particles of titania embedded in continuous alumina.

Method (3) utilizes binder particles alone or metal oxide template particles in combination with binder particles. A template of binder particles or colloidal metal oxide particles are embedded in a matrix of binder particles. The structure is heated resulting in a reaction of the binder particles, which results in the formation of a continuous matrix of metal oxide template particles or reacted binder particles.

Method (4) utilizes sol-gel synthesis of a metal oxide matrix. The template particles are dispersed in a solution of a metal oxide precursor, such as a metal alkoxide. Hydrolysis of the metal oxide precursor forms an intermediate that serves as a matrix in which the template particles are embedded. The structure is then heated to undergo hydrolysis and condensation of the matrix, resulting in the formation of a continuous matrix of metal oxide. In an illustrative example, alumina template particles are initially dispersed in a solution of tetraethyl orthosilicate (TEOS). Heating converts the TEOS to silica, resulting in the formation of a continuous matrix of silica in which the alumina template particles are embedded.

The resulting hybrid metal oxide particles may be micron-scaled, for example, having average diameters from about 0.5 μm to about 100 μm. In certain embodiments, the hybrid metal oxide particles have an average diameter from about 0.5 μm, about 0.6 μm, about 0.7 μm, about 0.8 μm, about 0.9 μm, about 1.0 μm, about 5.0 μm, about 10 μm, about 20 μm, about 30 μm, about 40 μm, about 50 μm, about 60 μm, about 70 μm, about 80 μm, about 90 μm, about 100 μm, or within any range defined by any of these average diameters (e.g., about 1.0 μm to about 20 μm, about 5.0 μm to about 50 μm, etc.). The metal oxide employed may also be in particle form, and the particles may be nano-scaled. The metal oxide matrix nanoparticles may have an average diameter, for example, of about 1 nm to about 120 nm. The metal oxide template nanoparticles may have an average diameter, for example, of about 50 nm to about 999 nm. One or more of the template nanoparticles or the matrix nanoparticles may be polydisperse or monodisperse. In certain embodiments, either metal oxide may be provided as metal oxide particles or may be formed from a metal oxide precursor, for example, via a sol-gel technique. An exemplary sol-gel process is described as follows: liquid droplets are generated from a particle dispersion (e.g., an aqueous particle dispersion with a pH of 3-5) comprising metal oxide template nanoparticles and a precursor of a metal oxide. The precursor may be, for example, TEOS or tetramethyl orthosilicate (TMOS) as a silica precursor, titanium propoxide as a titania precursor, or zirconium acetate as a zirconium precursor. The liquid droplets are dried to provide dried particles comprising a hydrolyzed precursor of metal oxide that surrounds and coats the metal oxide template nanoparticles.

Certain embodiments of the hybrid metal oxide particles exhibit color in the visible spectrum at a wavelength range selected from the group consisting of 380 nm to 450 nm, 451 nm to 495 nm, 496 nm to 570 nm, 571 nm to 590 nm, 591 nm to 620 nm, 621 nm to 750 nm, 751 nm to 800 nm, and any range defined therebetween (e.g., 496 nm to 620 nm, 450 nm to 750 nm, etc.). In some embodiments, the particles exhibit a wavelength range in the ultraviolet spectrum selected from the group consisting of 100 nm to 400 nm, 100 nm to 200 nm, 200 nm to 300 nm, and 300 nm to 400 nm.

In certain embodiments, the hybrid metal oxide particles are non-porous or substantially non-porous. In certain embodiments, the hybrid metal oxide particles can have, for example, an average diameter of from about 0.5 μm to about 100 μm. In other embodiments, the particles can have, for example, an average diameter of from about 1 μm to about 75 μm.

In certain embodiments, the hybrid metal oxide particles have an average diameter, for example, of from about 1 μm to about 75 μm, from about 2 μm to about 70 μm, from about 3 μm to about 65 μm, from about 4 μm to about 60 μm, from about 5 μm to about 55 μm, or from about 5 μm to about 50 μm; for example, from any of about 5 μm, about 6 μm, about 7 μm, about 8 μm, about 9 μm, about 10 μm, about 11 μm, about 12 μm, about 13 μm, about 14 μm, or about 15 μm to any of about 16 μm, about 17 μm, about 18 μm, about 19 μm, about 20 μm, about 21 μm, about 22 μm, about 23 μm, about 24 μm, or about 25 μm. Other embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the hybrid metal oxide particles can have, for example, an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

The term “metal oxide” refers to oxygen containing species of various metals, such as silicon, titanium, aluminum, zirconium, cerium, iron, zinc, indium, tin, chromium, antimony, bismuth, cobalt, gallium, lanthanum, molybdenum, neodymium, nickel, niobium, vanadium, or combinations thereof. In certain embodiments, the metal oxide materials of the hybrid metal oxide particles are independently selected from silica, titania, alumina, zirconia, ceria, iron oxides, zinc oxide, indium oxide, tin oxide, chromium oxide, or combinations thereof. In certain embodiments, the metal oxide are selected from SiO₂, TiO₂, Ti₂O₃, Al₂O₃, or Fe₂O₃. As an example, the matrix metal oxide comprises titania, and the template nanoparticles (occlusions) comprise silica.

In certain embodiments, a weight to weight ratio of the first metal oxide particles to the second metal oxide particles is from about 1/10, about 2/10, about 3/10, about 4/10, about 5/10 about 6/10, about 7/10, about 8/10, about 9/10, to about 10/9, about 10/8, about 10/7, about 10/6, about 10/5, about 10/4, about 10/3, about 10/2, or about 10/1. In certain embodiments, the weight to weight ratio is 2/3 or 3/2.

In certain embodiments, a particle size ratio of the metal oxide matrix particles to the metal oxide template particles is from 1/20 to 1/5 (e.g., 1/10).

In certain embodiments, the matrix nanoparticles have an average diameter of from about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the matrix nanoparticles have an average diameter of about 5 nm to about 150 nm, about 50 to about 150 nm, or about 100 to about 150 nm.

In certain embodiments, the occlusions (template nanoparticles) have an average diameter of from about 50 nm, about 100 nm, about 150 nm, about 200 nm, about 250 nm, or about 300 nm to about 350 nm, about 400 nm, about 450 nm, about 500 nm, about 550 nm, or about 600 nm.

In further embodiments, the hybrid metal oxide particles can have, for example, from about 60.0 wt % to about 99.9 wt % metal oxide, based on the total weight of the hybrid metal oxide particles. In other embodiments, the structural colorants comprise from about 0.1 wt % to about 40.0 wt % of one or more light absorbers, based on the total weight of the hybrid metal oxide particles. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt %, or about 85.0 wt % to any of about 88.0 wt %, about 91.0 wt %, about 94.0 wt %, about 97.0 wt %, about 98.0 wt %, about 99.0 wt %, or about 99.9 wt % metal oxide, based on the total weight of the hybrid metal oxide particles.

In certain embodiments, the hybrid metal oxide particles are prepared by a method comprising: generating liquid droplets from a particle dispersion comprising first metal oxide particles (e.g., matrix nanoparticles) and second metal oxide particles (e.g., template nanoparticles); drying the liquid droplets to provide dried particles comprising a matrix of the first metal oxide particles embedded with the second metal oxide particles; and sintering the dried particles to densify the matrix and obtain the hybrid metal oxide particles.

In certain embodiments, a liquid dispersion is first formed, for example, by mixing the first metal oxide particles (e.g., matrix nanoparticles) and the second metal oxide particles (e.g., template nanoparticles) in a liquid medium. In certain embodiments, the liquid dispersion is an aqueous dispersion, an oil dispersion, or a combination thereof.

In certain embodiments, the hybrid metal oxide particles may be recovered, for example, by filtration or centrifugation. The recovered particles may then be placed on a substrate, for example, and dried by evaporating the liquid medium. In certain embodiments, the drying comprises microwave irradiation, oven drying, drying under vacuum, drying in the presence of a desiccant, or a combination thereof to evaporate the liquid medium. In certain embodiments, the evaporation of the liquid medium may be performed in the presence of self-assembly substrates such as conical tubes or silicon wafers.

In certain embodiments, droplet formation and collection occur within a microfluidic device. Microfluidic devices are, for example, narrow channel devices having a micron-scaled droplet junction adapted to produce uniform size droplets, with the channels being connected to a collection reservoir. Microfluidic devices, for example, contain a droplet junction having a channel width of from about 10 μm to about 100 μm. The devices are, for example, made of polydimethylsiloxane (PDMS) and may be fabricated, for example, via soft lithography. An emulsion may be prepared within the device via pumping an aqueous dispersed phase and oil continuous phase at specified rates to the device where mixing occurs to provide emulsion droplets. Alternatively, an oil-in-water emulsion may be utilized. The continuous oil phase comprises, for example, an organic solvent, a silicone oil, or a fluorinated oil. As used herein, “oil” refers to an organic phase (e.g., an organic solvent) immiscible with water. Organic solvents include hydrocarbons, for example, heptane, hexane, toluene, xylene, and the like.

In certain embodiments with liquid droplets, the droplets are formed with a microfluidic device. The microfluidic device can contain a droplet junction having a channel width, for example, of from any of about 10 μm, about 15 μm, about 20 μm, about 25 μm, about 30 μm, about 35 μm, about 40 μm, or about 45 μm to any of about 50 μm, about 55 μm, about 60 μm, about 65 μm, about 70 μm, about 75 μm, about 80 μm, about 85 μm, about 90 μm, about 95 μm, or about 100 μm.

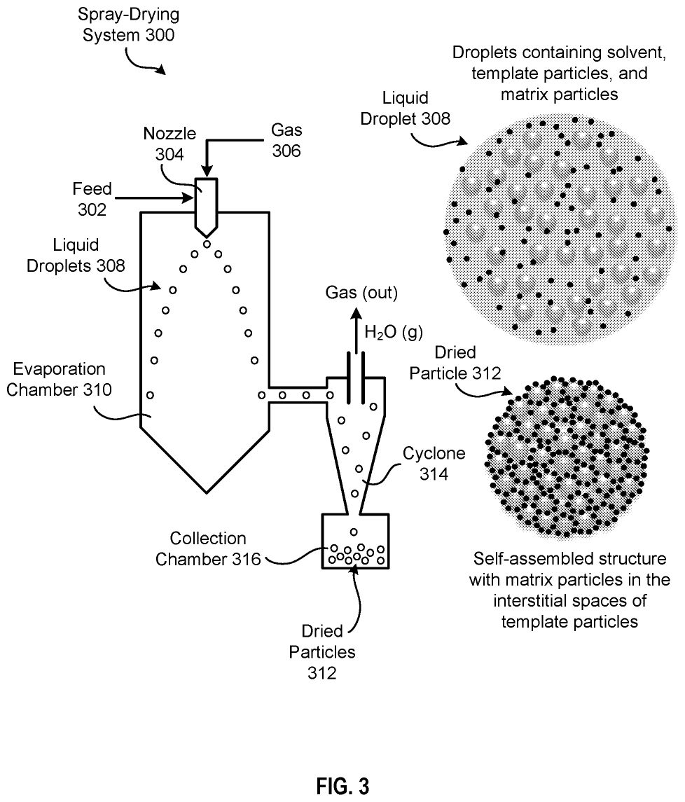

In certain embodiments, generating and drying the liquid droplets is performed using a spray-drying process. FIG. 3 shows a schematic of an exemplary spray drying system 300 used in accordance with various embodiments of the present disclosure. In certain embodiments of spray-drying techniques, a feed 302 of a liquid solution or dispersion is fed (e.g. pumped) to an atomizing nozzle 304 associated with a compressed gas inlet through which a gas 306 is injected. The feed 302 is pumped through the atomizing nozzle 304 to form liquid droplets 308. The liquid droplets 308 are surrounded by a pre-heated gas in an evaporation chamber 310, resulting in evaporation of solvent to produce dried particles 312. The dried particles 312 are carried by the drying gas through a cyclone 314 and deposited in a collection chamber 316. Gases include nitrogen and/or air. In an embodiment of an exemplary spray-drying process, a liquid feed contains a water or oil phase, metal oxide matrix particles, and metal oxide template particles. The dried particles 312 comprise a self-assembled structure of arrayed metal oxide template particles embedded in metal oxide matrix particles.

Air may be considered a continuous phase with a dispersed liquid phase (a liquid-in-gas emulsion). In certain embodiments, spray-drying comprises an inlet temperature of from any of about 100° C., about 105° C., about 110° C., about 115° C., about 120° C., about 130° C., about 140° C., about 150° C., about 160° C., or about 170° C. to any of about 180° C., about 190° C., about 200° C., about 210° C., about 215° C., or about 220° C. In some embodiments a pump rate (feed flow rate) of from any of about 1 mL/min, about 2 mL/min, about 5 mL/min, about 6 mL/min, about 8 mL/min, about 10 mL/min, about 12 mL/min, about 14 mL/min, or about 16 mL/min to any of about 18 mL/min, about 20 mL/min, about 22 mL/min, about 24 mL/min, about 26 mL/min, about 28 mL/min, or about 30 mL/min is utilized.

In some embodiments, vibrating nozzle techniques may be employed. In such techniques, a liquid dispersion is prepared, and then droplets are formed and dropped into a bath of a continuous phase. The droplets are then dried. Vibrating nozzle equipment is available from BUCHI and comprises, for example, a syringe pump and a pulsation unit. Vibrating nozzle equipment may also comprise a pressure regulation valve.

In certain embodiments, the dried hybrid metal oxide particles are subjected to sintering. The sintering can be performed at temperatures of from about 300° C. to about 800° C. for a period of from about 1 hour to about 8 hours. In some embodiments, if the template nanoparticles are monodisperse and ordered within the dried hybrid metal oxide particles prior to sintering, the ordered arrangement of the template nanoparticles may be substantially preserved in the hybrid metal oxide particles after sintering.

In certain embodiments, the hybrid metal oxide particles comprise mainly metal oxide, that is, they may consist essentially of or consist of metal oxide. Advantageously, depending on the particle compositions, relative sizes, and shapes of the metal oxide particles used, a bulk sample of the hybrid metal oxide particles may exhibit color observable by the human eye, may appear white, or may exhibit properties in the UV spectrum. A light absorber may also be present in the particles, which may provide a more saturated observable color. Absorbers include inorganic and organic materials, for example, a broadband absorber such as carbon black. Absorbers may, for example, be added by physically mixing the particles and the absorbers together or by including the absorbers in the droplets to be dried. In certain embodiments, a hybrid metal oxide particle may exhibit no observable color without added light absorber and exhibit observable color with added light absorber.

The hybrid metal oxide particles described herein may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved, for example, with the use of monodisperse metal oxide particles (e.g., template particles in the present embodiments). Angle-dependent color may also be achieved when a step of drying the liquid droplets is performed slowly, allowing the particles to become ordered. Angle-independent color may be achieved when a step of drying the liquid droplets is performed quickly, not allowing the particles to become ordered.

In some embodiments, the first metal oxide particles and/or the second metal oxide particles can comprise combinations of different types of particles. For example, the first metal oxide particles may be a mixture of two different metal oxides (i.e., discrete distributions of metal oxide particles), such as a mixture of alumina particles and silica particles with each species being characterized by the same or similar size distributions.

In some embodiments, the first metal oxide particles and/or the second metal oxide particles may comprise more complex compositions and/or morphologies. For example, the first metal oxide particles may comprise particles such that each individual particle comprises two or more metal oxides (e.g., silica-titania particles). Such particles may comprise, for example, an amorphous mixture of two or more metal oxides or may have a core-shell configuration (e.g., titania-coated silica particles, polymer-coated silica, carbon black-coated silica, etc.).

In some embodiments, the first metal oxide particles and/or the second metal oxide particles may comprise surface functionalization. An example of a surface functionalization is a silane coupling agent (e.g., silane-functionalized silica). In some embodiments, the surface functionalization is performed on the first metal oxide particles and/or the second metal oxide particles prior to self-assembly and densification. In some embodiments, the surface functionalization is performed on the hybrid metal oxide particles after densification.

To obtain reflectance over a wide spectral range, more than one type (a blend) of hybrid metal oxide particles can be incorporated in the coating compositions. A combination of two hybrid metal oxide particles can increase the spectral range over which reflectance is observed. In certain embodiments, the hybrid metal oxide particles exhibit an ability to disperse well into the coating compositions and thus uniformly coat a surface. In particular, the hybrid metal oxide particles are compatible with all types of solvent and coating systems such as acrylics and styrene-acrylic systems.

In certain embodiments, the hybrid metal oxide particles can include a minor amount of carbon containing material produced in situ from polymer decomposition. In certain embodiments, the hybrid metal oxide particles can include carbon black or a hydrocarbon material. Carbon black pigments has a high IR absorption and are conventionally used in coatings such as paints and stains. In certain embodiments of the coating compositions disclosed herein, controlled calcination can be employed to produce carbon black in situ in the hybrid metal oxide particles. The hybrid metal oxide particles can include materials other than the metal oxides (such as carbon black) in an amount of less than 35% by weight, (e.g., less than 20%, less than 15%, less than 10%, less than 5%, less than 2%, less than 1%, from 0% to 35%, from 0.1% to 20%, from 0.1% to 10%, from 0.1% to 5%, or from 0.1% to 2% by weight), based on the weight of the hybrid metal oxide particles.

In certain embodiments, the hybrid metal oxide particles can have an average occlusion diameter of 200 nm or greater, 250 nm or greater, 300 nm or greater, 350 nm or greater, 400 nm or greater, 450 nm or greater, 500 nm or greater, 550 nm or greater, 600 nm or greater, 650 nm or greater, 700 nm or greater, 750 nm or greater, or up to 800 nm or greater. In certain embodiments, the hybrid metal oxide particles can have an average occlusion diameter of 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, or 200 nm or less. The hybrid metal oxide particles can have an average occlusion diameter from any of the minimum values to any of the maximum values described above of the hybrid metal oxide particles. For example, the hybrid metal oxide particles can have an average occlusion diameter of from 200 nm to 800 nm, from 200 nm to 600 nm, from 200 nm to 400 nm, from 250 nm to 400 nm, or from 250 nm to 350 nm.

As discussed herein, the average occlusion size of the hybrid metal oxide particles can vary, depending on the size of the template metal oxide particles used. However, spherical monodispersed template metal oxide particles can be employed to create a substantially uniform and unimodal distribution of occlusion sizes. In other cases, a multimodal distribution of template metal oxide particles can be employed to create a multimodal distribution, such as a bimodal distribution, of occlusion sizes. In general, however, the occlusion size of the hybrid metal oxide particles is nano-scaled, such as from about 200 nm to about 400 nm. While the occlusion size significantly influences the color expressed by the particles, the shape and size distribution of occlusions as well as of the hybrid metal oxide particles can affect the color.

The following are illustrative examples of hybrid metal oxide particles having properties tuned for particular applications.

In a first example, 0.5 μm to 3 μm hybrid metal oxide particles with an average occlusion diameter of 50 nm to 400 nm can be used for UV protection for wood clear coatings. A typical coating composition may include, but is not limited to, the use of a polymer, water, a defoamer, pigment dispersant agent, one or multiple rheology modifying polymers, light stabilizers, wetting agents, fungicide/mildewcide agents, inorganic extenders, and organic or inorganic light absorbing pigments.

In a second example, 1 μm to 10 μm hybrid metal oxide particles with an average occlusion diameter of 100 nm to 800 nm can be used for opacity improvements in coatings. A typical coating composition can include, but is not limited to, the use of a polymer, water, a defoamer, one or multiple rheology modifying polymers, pigment dispersant agent, wetting agents, inorganic light scattering pigments, (e.g. TiO₂), fungicide/mildewcide agents, inorganic extenders, and organic or inorganic light absorbing pigments.

In a third example, greater than 5 μm hybrid metal oxide particles with an average occlusion diameter of 400 nm to 500 nm can be used for infrared reflection in coatings to prevent heat transfer into the body of the coating and substrate. A typical coating composition can include, but is not limited to, the use of a polymer, water, a defoamer, one or multiple rheology modifying polymers, pigment dispersant agent, wetting agents, inorganic light scattering pigments, (e.g. TiO₂), fungicide/mildewcide agents, inorganic extenders, and organic or inorganic light absorbing pigments.

In a fourth example, 1 μm to 5 μm hybrid metal oxide particles with an average occlusion diameter of 100 nm to 800 nm can be used to impart color to coatings. A typical coating composition can include, but is not limited to, the use of a polymer, water, a defoamer, one or multiple rheology modifying polymers, pigment dispersant agent, wetting agents, inorganic light scattering pigments, (e.g. TiO₂), fungicide/mildewcide agents, inorganic extenders, and organic or inorganic light absorbing pigments.

### Coating Compositions

The various coating compositions described herein, when dried, can exhibit UV reflectance, such as within a wavelength from 100 nm to 400 nm; visible light reflectance such as within a wavelength of from 400 to 800 nm; IR reflectance such as within a wavelength from 800 nm to 10 μm; reflectance within a wavelength of from 100 to 800 nm for providing improved opacity; or a combination thereof. The reflectance of the coatings with respect to the wavelength and intensity can be dependent on the physical characteristics (such as particle size, porosity, and pore size) as well as the chemical characteristics of the particles, as discussed herein.

While the hybrid metal oxide particles are substantially non-porous, they may be mixed, for example, with other particles that are porous (e.g., porous polymer microspheres). The porous particles by themselves, or the collective mixture of hybrid metal oxide particles with the porous particles, may have an overall measurable porosity. The term “porous,” as used herein, refers to one or more interconnected or non-interconnected pores, voids, spaces, or interstices that allow air or liquid to pass through. The term “porosity” as used herein refers to a measure of the empty spaces (or voids or pores) in the particles and is a ratio of the volume of voids to total volume of the mass of the porous particles between 0 and 1, or as a percentage between 0 and 100%. Average porosity of porous particles means the total pore volume, as a fraction of the volume of the entire porous particle. Mercury porosimetry analysis can be used to characterize the porosity of the particles. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. A mercury porosimeter generates volume and pore size distributions from the pressure versus intrusion data generated by the instrument using the Washburn equation. Porosity, as reported herein for porous particles, is calculated as a ratio of unoccupied space and total particle volume. For example, porous silica particles containing voids/pores with an average size of 165 nm have an average porosity of 0.8. The porous metal oxide spheres can contain uniform or non-uniform pore diameters.

In certain embodiments, the coating composition is a UV reflective composition. In some examples, the UV reflective composition can include hybrid metal oxide particles having an average diameter of from 1 μm to 10 μm (e.g., from 1 μm to 10 μm, from 2 μm to 10 μm, from 1 μm to 5 μm, from 0.5 μm to 3 μm, from 1 μm to 3 μm, from 1 μm to 2.5 μm, or from 1.5 μm to 3 μm); and an average occlusion diameter of from 50 nm to 400 nm (e.g., from 100 nm to 400 nm, from 50 nm to 350 nm, from 50 nm to 300 nm, from 50 nm to 250 nm, from 50 nm to 200 nm, from 150 nm to 400 nm, from 200 nm to 400 nm, or from 100 nm to 350 nm). In other examples, the UV reflective composition can be a clear coating compositions comprising a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof; and hybrid metal oxide particles having an average particle size diameter of from 1 μm to 10 μm, from 1 μm to 5 μm, or from 1 μm to 3 μm. The clear coating composition, when dried, can exhibit a UV reflectance at a wavelength range from 100 nm to 400 nm. The UV reflective compositions can further comprise one or more UV absorbers, such as selected from a hydroxy-phenyl-benzotriaziole, a hydroxy-phenyl-triazine, a hydroxyl-benzophenone, an oxanilide, a cyanoacrylate, a malonate, and a mixture thereof.

In certain embodiments, the coating composition is a colored coating composition comprising a polymer binder and a particles (e.g., microspheres) as described herein. In certain embodiments, the colored coating composition include hybrid metal oxide particles having an average diameter of from 1 μm to 20 μm, from 1 μm to 10 μm, from 1 μm to 5 μm, or from 3 μm to 5 μm; and an average occlusion diameter of from 200 nm to 800 nm (e.g., 200 nm to 400 nm, from 200 nm to 350 nm, or from 250 nm to 350 nm). The colored coating compositions, when dried, can exhibit a visible absorbance, such as within a wavelength of from 400 to 800 nm. The visible absorbance of the colored coating compositions with respect to the color can be dependent on the physical characteristics (such as particle size, occlusion size, and occlusion spacing) of the particles, as discussed herein.

In certain embodiments, the coating composition is a composition having improved opacity. In some examples, the composition having improved opacity can include hybrid metal oxide particles having an average diameter of from 0.5 μm to 100 μm (e.g., from 1 μm to 100 μm, from 1 μm to 50 μm, from 1 μm to 30 μm, from 1 μm to 20 μm, from 1 μm to 10 μm, from 1 μm to 8 μm, or from 2 μm to 7 μm); and an average occlusion diameter of from 50 nm to 800 nm (e.g., from 50 nm to 600 nm, from 50 nm to 400 nm, from 50 nm to 200 nm, from 100 nm to 800 nm, from 100 nm to 600 nm, from 100 nm to 400 nm, from 200 nm to 800 nm, from 200 nm to 400 nm, from 250 nm to 400 nm, or from 200 nm to 350 nm). In other examples, the coating compositions exhibiting improved opacity are paint compositions comprising a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof, and hybrid metal oxide particles, wherein the particles have an average particle size diameter of 100 μm or less, 50 m or less, more 10 μm or less, or from 1 μm to 10 μm, and an average porosity of from or from 0.40 to 0.65, or from 0.45 to 0.55.

In certain embodiments, the coating composition is an IR reflective composition. In some examples, the IR reflective composition can include hybrid metal oxide particles having an average diameter of from 5 μm to 100 μm (e.g., from 5 μm to 75 μm, from 5 μm to 50 μm, or from 10 μm to 30 μm); and an average occlusion diameter of from 400 nm to 10 μm (e.g., from 400 nm to 5 μm, from 400 nm to 2.5 μm, from 400 nm to 1 μm, from 800 nm to 10 μm, from 800 nm to 5 μm, from 800 nm to 2.5 μm, from 800 nm to 1.5 μm, or from 800 nm to 1 μm). In some examples, the IR reflective composition can include hybrid metal oxide particles having an average diameter of greater than about 50 μm (e.g., from 80 μm to 100 μm or about 100 μm); and an average occlusion diameter of from 400 nm to 10 μm (e.g., from 400 nm to 5 μm, from 400 nm to 2.5 μm, from 400 nm to 1 μm, from 800 nm to 10 μm, from 800 nm to 5 μm, from 800 nm to 2.5 μm, from 800 nm to 1.5 μm, or from 800 nm to 1 μm). In some examples, the IR reflective composition can include hybrid metal oxide particles having an average diameter of less than about 5 μm (e.g., about 5 μm); and an average occlusion diameter of from 400 nm to 1 μm (e.g., from 400 nm to 900 nm, from 400 to 800 nm, from 400 to 750 nm, or from 400 to 700 nm).

In other examples, the IR reflective coating composition comprises a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, alkyd resin, polyester resins, polyurethane resins, silicone resins, petroleum resins, epoxy resins, blends thereof, or copolymers thereof, and hybrid metal oxide particles, wherein the particles have an average particle size diameter of 5 μm or greater or from 5 μm to 100 m and an average porosity of from or from 0.40 to 0.65 or from 0.45 to 0.55, and wherein the coating composition when dried exhibits an IR reflectance at a wavelength range from 800 nm to 10 μm, from 800 nm to 2.5 μm, or from 800 nm to 1 μm.

The coating compositions can include the particles (e.g., hybrid metal oxide particles, polymer particles, or a combination thereof) in an amount from greater than 0% by weight to 99.9% by weight (e.g., 0.1% or greater, 0.5% or greater, 1% or greater, 2.5% or greater, 5% or greater, 7% or greater, 10% or greater, 12.5% or greater, 15% or greater, 20% or greater, 22% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, 90% or greater, 95% or greater, or up to 99.9% by weight), based on the total dry weight of the coating composition. The coating composition can include the particles in an amount of 99.9% by weight or less, 99% by weight or less, 98% by weight or less, 95% by weight or less, 90% by weight or less, 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, 8% by weight or less, 7% by weight or less, 6% by weight or 5% by weight or less, 4% by weight or less, 3% by weight or less, 2% by weight or less, or 1% by weight or less), based on the total dry weight of the coating composition. The coating composition can include the particles in an amount from 0.1% by weight to 99.9% by weight, from 0.5% by weight to 99% by weight, from 0.5% by weight to 95% by weight, from 1% by weight to 90% by weight, from 5% by weight to 99.9% by weight, from 10% by weight to 90% by weight, from 15% by weight to 85% by weight, based on the total dry weight of the coating composition.

The coating composition can include the polymer binder in an amount from greater than 0% by weight to 99.9% by weight (e.g., 0.1% or greater, 0.5% or greater, 1% or greater, 2.5% or greater, 5% or greater, 7% or greater, 10% or greater, 12.5% or greater, 15% or greater, 20% or greater, 22% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, 90% or greater, 95% or greater, or up to 99.9% by weight), based on the total dry weight of the coating composition. The coating composition can include the polymer binder in an amount of 99.9% by weight or less, 99% by weight or less, 98% by weight or less, 95% by weight or less, 90% by weight or less, 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, 8% by weight or less, 7% by weight or less, 6% by weight or 5% by weight or less, 4% by weight or less, 3% by weight or less, 2% by weight or less, or 1% by weight or less), based on the total dry weight of the coating composition. The coating composition can include the polymer binder in an amount from 0.1% by weight to 99.9% by weight, from 0.5% by weight to 99% by weight, from 0.5% by weight to 95% by weight, from 1% by weight to 90% by weight, from 5% by weight to 99.9% by weight, from 10% by weight to 90% by weight, from 15% by weight to 85% by weight, based on the total dry weight of the coating composition.

The coating compositions can include additional components. For example, the coating compositions can include an additive such as a pigment dispersant, an inorganic or organic filler, an additional pigment, a pigment extender, a thickener, a defoamer, a surfactant, a biocide, an adhesion enhancer, a coalescing agent, a film forming aid, a flame retardant, a stabilizer, a curing agent, a flow agent, a leveling agent, a hindered amine light stabilizer, an antioxidant, a wetting agent, a hardener, a tackifier, an anti-settling aid, a texture-improving agent, an antiflocculating agent, or a combination thereof. The additive can be added to impart certain properties to the coating compositions such as thickness, texture, handling, fluidity, smoothness, whiteness, increased density or weight, decreased porosity, increased opacity, flatness, glossiness, decreased blocking resistance, barrier properties, and the like.

In certain embodiments, the coating compositions include a mineral filler and/or a pigment. When present, the mineral filler and/or pigment can be selected from TiO₂ (in both anatase and rutile forms), clay (aluminum silicate), CaCO₃ (in both ground and precipitated forms), aluminum trihydrate, fly ash, or aluminum oxide, silicon dioxide, magnesium oxide, talc (magnesium silicate), barytes (barium sulfate), zinc oxide, zinc sulfite, sodium oxide, potassium oxide, and mixtures thereof. Examples of commercially available titanium dioxide pigments are KRONOS® 2101, KRONOS® 2310, available from Kronos WorldWide, Inc., TI-PURE® R-900, available from DuPont, or TIONA® ATl commercially available from Millennium Inorganic Chemicals. Titanium dioxide is also available in concentrated dispersion form. An example of a titanium dioxide dispersion is KRONOS® 4311, also available from Kronos Worldwide, Inc. Suitable pigment blends of mineral fillers are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), wollastonite (calcium metasilicate), and combinations thereof. In certain embodiments, the coating compositions can include TiO₂, CaCO₃, and/or a clay. In certain embodiments, the coating composition does not include a pigment and/or a mineral filler other than the particles (e.g., the hybrid metal oxide particles, the polymer particles, or the combination thereof).

When present, the mineral filler and/or pigment can comprise particles having a number average particle size of 50 μm or less (e.g., 45 μm or less, 40 μm or less, 35 μm or less, m or less, 25 μm or less, 20 μm or less, 18 μm or less, 15 μm or less, 10 μm or less, 8 μm or less, or 5 μm or less). In certain embodiments, the mineral filler and/or pigment can have a number average particle size of 10 μm or greater, 12 μm or greater, 15 μm or greater, 20 μm or greater, 25 μm or greater, 30 μm or greater, 35 μm or greater, 40 μm or greater, or 45 μm or greater. In certain embodiments, the pigment and/or mineral filler can have a number average particle size of from 10 μm to 50 μm, from 10 μm to 35 μm, or from 10 μm to 25 μm.

The mineral filler and/or pigment, if present, can be present in an amount of 1% or greater, based on the total weight of the coating composition. For example, the mineral filler and/or pigment can be present in an amount of from 1% to 85%, from 10% to 85%, from 15% to 75% or from 15% to 65%, based on the total weight of the coating composition. The coating compositions can include particles (e.g., hybrid metal oxide particles, polymer particles, or a combination thereof) and a combination of mineral fillers and pigments in weight ratios of 90:10, 80:20, 70:30, 60:40, 50:50, 40:60, 30:70, 20:80 or 10:90. In some cases, the coating composition can include from 0.1% to 90% (e.g., from 1% to 60%, from 1% to 55%, from 1% to 50%, or from 5% to 50%) of particles and/or mineral fillers and/or pigments, based on the total weight of the coating composition.

Examples of suitable pigment dispersing agents for use in the coating compositions are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener. Other suitable thickeners that can be used in the coating compositions can include acrylic copolymer dispersions sold under the STEROCOLL™ and LATEKOLL™ trademarks from BASF Corporation, Florham Park, NJ; urethanes thickeners sold under the RHEOVIS™ trademark (e.g., Rheovis PU 1214); hydroxyethyl cellulose; guar gum; carrageenan; xanthan; acetan; konjac; mannan; xyloglucan; and mixtures thereof. The thickeners can be added to the composition compositions as an aqueous dispersion or emulsion, or as a solid powder.

Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In certain embodiments, the coating compositions can include one or more coalescing aids such as propylene glycol n-butyl ether and/or dipropylene glycol n-butyl ether. The coalescing aids, if present, can be present in an amount of from greater than 0% to 30%, based on the dry weight of the polymer binder. For example, the coalescing aid can be present in an amount of from 10% to 30%, from 15% to 30% or from 15% to 25%, based on the dry weight of the polymer binder. In certain embodiments, the coalescing aid can be included in coating compositions comprising a high Tg polymer binder (that is a polymer having a Tg greater than ambient temperature (e.g., 20° C.)). In these embodiments, the coalescing aid can be present in an effective amount to provide coating compositions having a Tg less than ambient temperature (e.g., 20° C.). In certain embodiments, the compositions do not include a coalescing aid.

Defoamers serve to minimize frothing during mixing and/or application of the coating compositions. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Plasticizers can be added to the coating compositions to reduce the glass transition temperature (T_{g}) of the compositions below that of the drying temperature to allow for good film formation. Suitable plasticizers include diethylene glycol dibenzoate, dipropylene glycol dibenzoate, tripropylene glycol dibenzoate, butyl benzyl phthalate, or a combination thereof. Exemplary plasticizers include phthalate-based plasticizers. The plasticizer can be present in an amount of from 1% to 15%, based on the dry weight of the polymer binder. For example, the plasticizer can be present in an amount of from 5% to 15% or from 7% to 15%, based on the dry weight of the polymer binder. In certain embodiments, the plasticizer can be present in an effective amount to provide coating compositions having a Tg less than ambient temperature (e.g., 20° C.). In certain embodiments, the compositions do not include a plasticizer.

Suitable surfactants include nonionic surfactants and anionic surfactants. Examples of nonionic surfactants are alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof. In certain embodiments, the compositions do not include an ammonia-based pH modifier. The pH of the dispersion can be greater than 7. For example, the pH can be 7.5 or greater, 8.0 or greater, 8.5 of greater, or 9.0 or greater.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof. Exemplary dispersants can include sodium polyacrylates in aqueous solution such as those sold under the DARVAN trademark by R.T. Vanderbilt Co., Norwalk, CT.

In certain embodiments, the coating compositions described herein can have a total solids content of from 20% to 99% by weight (e.g., 25% to 95% by weight, 35% to 90% by weight, or 45% to 90%) by weight).

The coating compositions can be used for several applications, including in architectural coatings such as an architectural paint, industrial coatings, or inks, which are further discussed herein. In some examples, the coating compositions can be provided as a paint, such as an aqueous based paint, a semi-gloss paint, or a high gloss paint. In certain embodiments, the coating formulation can comprise less than or equal to 50 grams per liter of volatile organic compounds.

Generally, coatings are formed by applying the coating composition as described herein to a surface and allowing the coating to dry (e.g., removal of 95% by weight or greater, such as from 95% to 99% by weight of volatiles) to form a dried coating, such as a film. The surface can be, for example, wood, glass, metal, wood, plastic, asphalt, concrete, ceramic material or another coating layer applied on such a surface. Specific surfaces include wall, PVC pipe, brick, mortar, carpet, granule, pavement, ceiling tile, sport surface, exterior insulation and finish system (EIFS), polyurethane foam surface, polyolefin surface, ethylene-propylene diene monomer (EPDM) surface, roof, vinyl, and another coating surface (in the case of recoating applications).

The coating composition can be applied to a surface by any suitable coating technique, including spraying, rolling, brushing, or spreading. The composition can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The thickness of the resultant coating compositions can vary depending upon the application of the coating. For example, the coating can have a dry thickness of at least 0.5 μm, (e.g., at least 10 μm, at least 15 μm, at least 20 μm, at least 25 μm, at least 30 μm, at least 40 μm, at least 50 μm, at least 60 μm, at least 75 μm, at least 85 μm, at least 100 μm, at least 150 μm, at least 200 μm, at least 250 μm, at least 300 μm, at least 350 μm, at least 400 μm, at least 450 μm, or at least 500 am. In some instances, the coating compositions has a dry thickness of less than 500 m (e.g., 450 μm or less, 400 μm or less, 350 μm or less, 300 μm or less, 250 μm or less, 200 μm or less, 150 μm or less, 100 μm or less, 75 μm or less, 50 μm or less, 40 μm or less, 30 m or less, 25 μm or less, or 20 μm or less. In certain embodiments, the coating compositions has a dry thickness of between 0.5 m and 500 μm, from 0.5 μm to 250 μm, from 0.5 μm to 75 μm, or from 5 μm to 75 μm.

As described herein, the coating compositions when dried, can exhibit visible light absorbance. The coatings may also exhibit UV reflectance, visible light reflectance, IR reflectance, or a combination thereof. In certain embodiments, the dried coating compositions exhibit UV reflectance at a wavelength from 100 nm to 400 nm of at least 10%, at least 25%, at least 30%, at least 35%, at least 40%, at least 45%, at least 50%, at least 55%, at least 60%, or at least 70% or greater. In certain embodiments, the dried coating compositions exhibit UV reflectance at a wavelength from 100 nm to 400 nm of from 10% to 99%, from 10% to 90%, from 10% to 80%, or from 30% to 85%.

In certain embodiments, the coating compositions when dried, exhibit IR reflectance at a wavelength from 800 nm to 10 μm (or from 800 to 5 μm) of at least 10%, at least 25%, at least 30%, at least 35%, at least 40%, at least 45%, at least 50%, at least 55%, at least 60%, or at least 70% or greater. In certain embodiments, the dried coating compositions exhibit IR reflectance at a wavelength from 800 nm to 10 μm (or from 800 to 5 μm) of from 10% to 99%, from 10% to 90%, from 10% to 80%, or from 30% to 85.

In certain embodiments, the coating compositions form wet films having improved opacity. For example, wet films having a thickness of 75 μm, can exhibit a light scattering coefficient of greater than 1 S/mil, or greater than 3 S/mil, and an absorption coefficient of less than 0.02 K, as determined according to BS EN ISO 6504-1. In specific embodiments, the film formed from the paint composition having a thickness of 75 μm can have a contrast ratio of at least 90% (e.g., 91% or greater, 92% or greater, 93% or greater, 94% or greater, 95% or greater, 95% or greater, or greater than 96%). In certain embodiments, the coating compositions having improved opacity when dried, exhibit reflectance at a wavelength from 100 nm to 800 nm (or from 100 to 400 nm) of at least 10%, at least 25%, at least 30%, at least 35%, at least 40%, at least 45%, at least 50%, at least 55%, at least 60%, or at least 70% or greater.

The polymer binder in the coating compositions can be prepared by any polymerization method known in the art. In certain embodiments, the polymer binder can be prepared by a dispersion, a mini-emulsion, or an emulsion polymerization.

Methods of making the coating compositions can include mixing the polymer binder with one or more or the particles (e.g., hybrid metal oxide particles, polymer particles, or a combination thereof) described herein.

Methods for protecting a substrate against UV or IR-radiation are also provided. The method can include applying a UV coating composition or an IR coating composition as described herein to the surface. The surface can be glass, metal, wood, plastic, concrete, vinyl, ceramic material or another coating layer applied on such surface.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Preparation of Colored Coatings

Colored coatings can be prepared by mixing hybrid metal oxide particles having a particle diameter of from 3 to 5 m and occlusion diameters of from 400 to 800 nm with a polymer binder, water, and optionally a defoamer, a pigment dispersant agent, one or multiple rheology modifying polymers, a light stabilizer, a wetting agent, a fungicide/mildewcide agent, an inorganic pigment extender, or an organic or inorganic light absorbing pigment. It is believed that the hybrid metal oxide particles in the colored coatings can provide improved permanence, improved durability, and full color representations.

### Example 2: Preparation of UV Protective Coatings

UV protective coatings including clear coatings for wood can be prepared by mixing hybrid metal oxide particles having a particle diameter of from 1 to 10 μm, from 1 to m, or from 1 to 3 m and occlusion diameters of from 50 to 400 nm or from 50 to 200 nm with a polymer binder, water, and optionally a defoamer, a pigment dispersant agent, one or multiple rheology modifying polymers, a light stabilizer, a wetting agent, a fungicide/mildewcide agent, an inorganic pigment extender, or an organic or inorganic light absorbing pigment. It is believed that the particles in the UV protective coatings can mitigate effects from UV radiation, offering improved coating performance and can be used to replace existing technologies used in UV protective coatings.

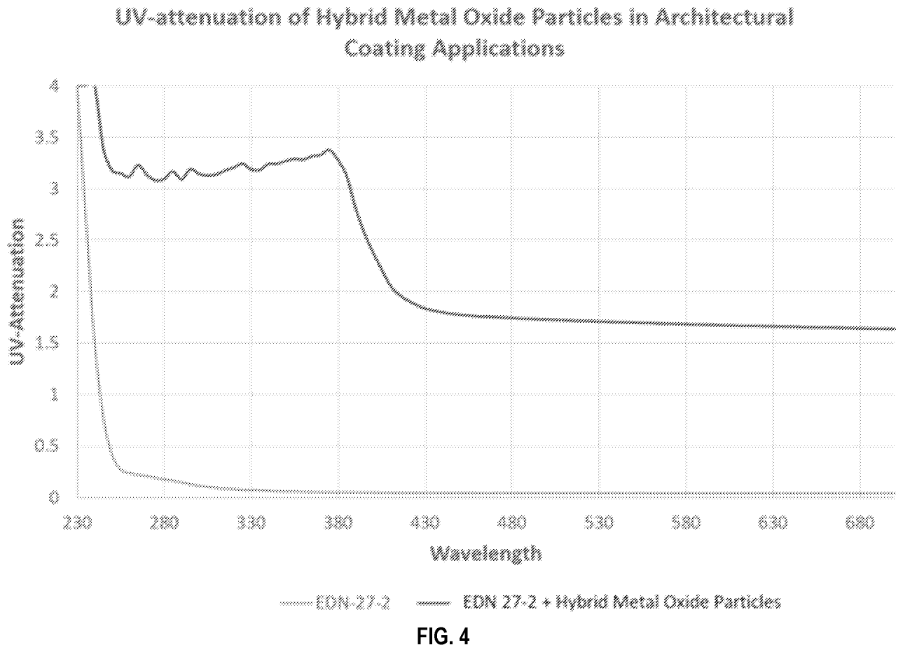

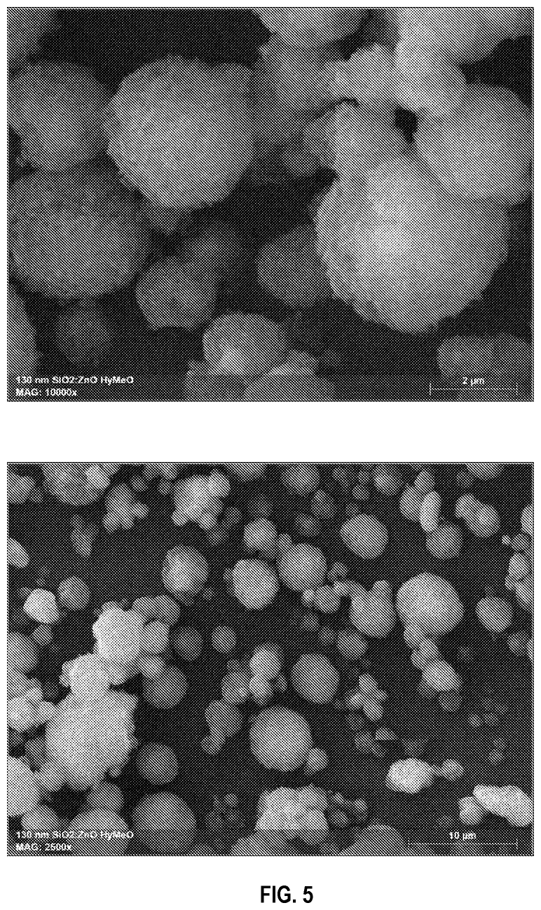

Hybrid metal oxide microspheres that were designed to reflect UV light were added to a commercially representative, BASF formulated wood deck clear coating and the UV attenuation measured. FIG. 4 is plot of UV attenuation for a coating prepared with hybrid metal oxide particles compared to a control coating prepared without hybrid metal oxide particles, showing significant UV attenuation in the range of 230 nm to 380 nm compared to the control. FIG. 5 shows scanning electron micrographs of the hybrid metal oxide particles prepared from silica nanosphere templates of approximately 130 nm in diameter and bound by a zinc oxide matrix.

### Example 3: Preparation of Coatings with Improved Opacity

Coatings having improved opacity such as paints can be prepared by mixing hybrid metal oxide particles having a particle diameter of from 1 to 100 μm or from 1 to 10 μm and occlusion diameters of from 50 to 800 nm, from 50 to 400 nm, or from 50 to 200 nm with a polymer binder, water, and optionally a defoamer, a pigment dispersant agent, one or multiple rheology modifying polymers, a light stabilizer, a wetting agent, a fungicide/mildewcide agent, an inorganic pigment extender, an organic or inorganic light absorbing pigment, or an organic or inorganic light scattering pigment (e.g. TiO₂). It is believed that the light scattering efficiency of the coatings can exceed that of rutile titanium dioxide, which is currently used in coatings for light scattering characteristics.

### Example 4: Preparation of IR Protective Coatings

IR protective coatings including can be prepared by mixing hybrid metal oxide particles having a particle diameter of 5 μm or greater (such as from 5 μm to 100 m) and occlusion diameters of from 400 to 10000 nm or from 400 to 1000 nm with a polymer binder, water, and optionally a defoamer, a pigment dispersant agent, one or multiple rheology modifying polymers, a light stabilizer, a wetting agent, a fungicide/mildewcide agent, an inorganic pigment extender, an organic or inorganic light absorbing pigment, or an organic or inorganic light scattering pigment (e.g. TiO₂). It is believed that the spheres in the IR protective coatings can mitigate effects from IR radiation, preventing heat transfer into the body of the coating and the substrate.

In the foregoing description, numerous specific details are set forth, such as specific materials, dimensions, processes parameters, etc., to provide a thorough understanding of the embodiments of the present disclosure. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising,” or variations thereof, as used herein is used synonymously with the term “including,” or variations thereof, and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” in various places throughout this specification are not necessarily all referring to the same embodiment, and such references mean “at least one.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A coating composition comprising:
a polymer binder; and
hybrid metal oxide particles,
wherein the hybrid metal oxide particles have an average particle size diameter of from 0.5 μm to 100 μm, and
wherein the coating composition when dried exhibits a UV reflectance within a wavelength from 100 nm to 400 nm; a visible light reflectance within a wavelength of from 400 to 800 nm; an IR reflectance within a wavelength from 800 nm to 10 μm; or a combination thereof.

2. The coating composition of claim 1, wherein the polymer binder comprises a polymer selected from acrylic homopolymers, styrene-acrylic-based copolymers, styrene-butadiene-based copolymers, styrene-butadiene-styrene block copolymers, vinyl acrylic-based copolymers, ethylene vinyl acetate-based copolymers, polychloroprene, alkyd resin, polyester resins, polyurethane resins, silicone resins, petroleum resins, epoxy resins, or blends thereof.

3. The coating composition of claim 1, wherein each hybrid metal oxide particle comprises a continuous matrix of a first metal oxide having embedded therein an array of metal oxide particles, the metal oxide particles comprising a second metal oxide, wherein the hybrid metal oxide particles are substantially non-porous.

4. (canceled)

5. (canceled)

6. The coating composition of claim 3, wherein the first metal oxide and the second metal oxide independently comprise a metal oxide selected from silica, titania, alumina, zirconia, ceria, iron oxides, zinc oxide, indium oxide, tin oxide, chromium oxide, and combinations thereof.

7. The coating composition of claim 3, wherein a weight to weight ratio of the first metal oxide to the second metal oxide is from about 1/50 to about 10/1.

8. The coating composition of claim 1, wherein the coating composition is an aqueous composition.

9. The coating composition of claim 1, wherein the hybrid metal oxide particles comprise a multimodal distribution, a bimodal distribution, or a unimodal distribution of metal oxide occlusions.

10. The coating composition of claim 1, wherein the hybrid metal oxide particles have an average diameter from about 1 μm to about 10 μm, and an average metal oxide occlusion diameter of from about 100 nm to about 800 nm.

11. The coating composition of claim 1, wherein the composition is a UV reflective composition, and the hybrid metal oxide particles have one or more of an average diameter from 1 μm to 3 μm, or an average metal oxide occlusion diameter from 50 nm to 400 nm.

12. The coating composition of claim 1, wherein the coating composition exhibits improved opacity, and the hybrid metal oxide particles have one or more of an average diameter from 1 μm to 10 μm, or an average metal oxide occlusion diameter from 50 nm to 400 nm.

13. The coating composition of claim 1, wherein the coating composition is an IR reflective composition, and the hybrid metal oxide particles have one or more of an average diameter of from greater than 5 μm to 100 μm, and an average metal oxide occlusion diameter from 400 nm to 5 μm.

14. The coating composition of claim 1, wherein the hybrid metal oxide particles is a colored coating composition, and the hybrid metal oxide particles have one or more of an average diameter from about 1 μm to about 5 μm, or an average metal oxide occlusion diameter of from about 100 nm to about 800 nm.

15. The coating composition of claim 3, wherein a weight to weight ratio of the first metal oxide to the second metal oxide is from about 1/50 to about 10/1.

16. The coating composition of claim 1, wherein the hybrid metal oxide particles comprise from 60% to 99.9% by weight metal oxide, based on a total weight of the hybrid metal oxide particles.

17. The coating composition of claim 1, wherein the hybrid metal oxide particles exhibit an angle-dependent structural color.

18-20. (canceled)

21. A film derived from the coating composition of claim 1, after application to a substrate as a coating and after drying.

22-25. (canceled)

26. A clear coating composition comprising:
a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof; and
hybrid metal oxide particles,
wherein the hybrid metal oxide particles have an average particle size diameter from 0.5 μm to 3 μm, and
wherein the clear coating composition when dried exhibits a UV reflectance at a wavelength range from 100 nm to 400 nm.

27. (canceled)

28. A method for protecting a substrate against UV-radiation, the method comprising applying a clear coating composition according to claim 26 to the substrate.

29. A paint comprising the coating composition of claim 1, wherein the paint is selected from an aqueous based paint or an oil-based paint.

30. A paint composition comprising:
a polymer selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, blends thereof, or copolymers thereof; and
hybrid metal oxide particles, wherein the particles have an average particle size diameter from 0.5 μm to 10 μm.

31. (canceled)
